(19) United States
(12) Patent Application Publication
(10) Pub. No.: US 2015/0189097 A1
(43) Pub. Date: Jul. 2, 2015

(54) VECTORED CHARGING DATA RECORD (CDR) RECONCILIATION

(71) Applicant: Alcatel-Lucent USA Inc., Murray Hill, NJ (US)

(72) Inventors: Ranjan Sharma, New Albany, OH (US); Yigang Cai, Naperville, IL (US)

(21) Appl. No.: 14/145,217

(22) Filed: Dec. 31, 2013

(51) Int. Cl. H04M 15/00

(52) U.S. Cl. CPC H04M 15/65; H04M 15/56

(57) ABSTRACT

An example method includes receiving at a first network node one or more Accounting Requests (ACRs) from one or more network elements, the one or more ACRs including charging information, at least one of the one or more ACRs including an indicator indicating retransmission of the at least one ACR, and generating a Charging Data Record (CDR) using the charging information in the one or more ACR received. The generated CDR includes an indicator that the CDR has used a potentially retransmitted ACR and an identification of one or more usage containers that are reported by the CDR. The indicator may include a portion of payload information of the potentially retransmitted ACR. The identification of one or more usage containers identifies each accounting record number that is included in the CDR. CDRs so modified may be utilized to perform a reconciliation of CDRs and generation of non-overlapped session CDRs.

### FIELD

The invention is related to the field of communications and, in particular, to offline charging in communication networks.

### BACKGROUND

Service providers are able to provide numerous voice and data services to end user devices (also referred to as subscribers, user equipment, wireless devices, end users, and the like, etc.). Examples of voice services are voice calls, call forwarding, call waiting, etc. Examples of data services are streaming audio, streaming video, Voice over Internet Protocol (VoIP), online gaming, IP-TV, etc. The data services are managed by a Packet-Switched (PS) core network, which interfaces the end user device with one or more external Packet Data Networks (PDN), such as the Internet. When accessing data services, the sessions established by end user devices are typically much longer in duration than traditional voice calls. For instance, a typical voice call may last ten minutes or less, while data sessions for surfing the Internet, watching IP-TV, playing online games, etc., may last for many hours or even days.

PS core networks, such as the Evolved Packet Core (EPC), allow end user devices to engage in data sessions that are “always on”. “Always-on” sessions may be active over the PS core network for several hours or several days. Although the session is active, there may be idle periods where the end user device is not sending or receiving data. For example, if an end user device is logged into an online game, a session will be active while the end user device is logged in; however, since the game may not be played actively and/or continuously when logged in, there may be corresponding idle periods during the gaming session when the end user device is not actually consuming data with respect to the gaming session.

End user devices that are served by a PS core network may subscribe to offline charging. Offline charging refers to a charging method where charging information for network resource usage is collected concurrently with the resource usage. When network elements in the PS core network provide services for a session, the network elements are configured to report charging events to an Offline Charging System (OFCS) when certain trigger conditions are met. Some examples of triggers for charging events are data volume limits and time limits. For a data volume limit, a charging event is triggered if the volume of downlink data and/or uplink data for an end user device exceeds a maximum. For example, the downlink limit may be one-hundred (100) megabytes (MB), and the uplink limit may be ten (10) MB. For the time limit, a charging event may be triggered if a time limit has expired since the last charging event. For example, the time limit may be fifteen (15) minutes. Other numerical limits may be set for the data volume limit and time limit Other types of trigger conditions may be specified, such as described in the 3rd Generation Partnership Project (3GPP) Technical Specification (TS) 32.251, hereby incorporated by reference.

When trigger conditions are detected, the network element reports the charging event to the OFCS in the form an accounting request (ACR), such as a Diameter Rf ACR. More specifically, when a trigger condition is detected, a Charging Trigger Function (CTF) reports an ACR to a Charging Collection Function (CCF). A CCF is configured to receive ACRs and use the charging information contained in the ACRs to construct Charging Data Records (CDRs). The CCF of the OFCS generates CDR for the each of the network elements based on the ACRs that are received. A CDR is a formatted collection of information about a chargeable telecommunication event (e.g., making a phone call, using a mobile device to obtain a service, etc.). Information on chargeable events may include time of call set-up, duration of the call, amount of data transferred, media utilized, etc. and the like. A separate CDR is generated for each party to be charged. At some point in time, the CCF of OFCS passes the CDRs to a Billing Domain (BD) for generation of a bill at the end of a billing cycle (e.g., a monthly billing cycle). The network operator is then able to send a bill to the responsible party for the end user device that specifies the usage by the end user device during the billing cycle.

Unfortunately, network operators can experience problems to when attempting to charge for these sessions.

### SUMMARY

Embodiments described herein are directed to the formation of a CDR that allows for billing reconciliation. In one embodiment, a method includes receiving at a first network node one or more Accounting Requests (ACRs) from one or more network elements, the one or more ACRs including charging information, at least one of the one or more ACRs including an indicator indicating retransmission of the at least one ACR, and generating a Charging Data Record (CDR) using the charging information in the one or more ACR received. The generated CDR includes an indicator that the CDR has used a potentially retransmitted ACR and an identification of one or more usage containers that are reported by the CDR.

In one embodiment, the indicator comprises a portion of payload information of the potentially retransmitted ACR.

In one embodiment, the portion of payload information comprises one or more of an accounting record number (ARN), calling party address, called party address, service request time, delivery start time, delivery end times, and list of media components utilized.

In one embodiment, the indicator comprises a sequence of information concerning a plurality of potentially retransmitted ACR, each element of the sequence comprising a portion of payload information of a respective one of the plurality of potentially retransmitted ACR.

In one embodiment, the identification of one or more usage containers is a field that lists one or more contained accounting record numbers (ARNs).

In one embodiment, the identification is a sequence which identifies each accounting record number that is included in the CDR.

In one embodiment, the method also includes receiving at a Billing Domain (BD) a plurality of CDRs from a plurality of charging collection functions of an offline charging system, and reconciling the plurality of CDRs to generate non-overlapped session CDRs based on the indicator and the identification of at least one of the plurality of CDRs.

In one embodiment, reconciling includes extracting from the plurality of CDRs billing information that is not duplicated, and adjusting one or more of timestamps or media components of at least one of the plurality of CDRs.

In one embodiment, the method also includes collapsing the plurality of CDRs into a set of CDRs, a size of the set of CDRs smaller in number than a size of the plurality of CDRs. For example, a set of CDRs can be collapsed into a single CDR.

In another embodiment, an apparatus includes a network element for a communication network for serving a communication session. The network element is configured to receive one or more Accounting Requests (ACRs) from one or more network elements, the one or more ACRs including charging information, respective ACRs including a retransmission indicator when the respective ACR is retransmitted. The network element is also configured to construct a Charging Data Record (CDR) using the charging information in the one or more ACR received. The CDR includes an indicator that the CDR has used a potentially retransmitted ACR and an identification of one or more usage containers that are reported by the CDR.

In one embodiment, the indicator comprises a portion of payload information of the potentially retransmitted ACR.

In one embodiment, the portion of payload information comprises one or more of an accounting record number (ARN), calling party address, called party address, service request time, delivery start time, delivery end times, and list of media components utilized.

In one embodiment, the indicator comprises a sequence of information concerning a plurality of potentially retransmitted ACR, each element of the sequence comprising a portion of payload information of a respective one of the plurality of potentially retransmitted ACR.

In one embodiment, the identification of one or more usage containers is a field that lists one or more contained accounting record numbers (ARNs).

In one embodiment, the identification is a sequence which identifies each accounting record number that is included in the CDR.

In yet another embodiment, a system includes one or more first-type network elements, each of the one or more first-type network elements including a Charging Trigger Function (CTF) and an Offline Charging System (OFCS) including a plurality of Charging Collection Functions (CCF). The one or more first-type network elements are connected to the OFCS. The CTF generates a charging event based on observation of network resource usage and generates an Accounting Request (ACR) including charging information in response to the charging event. The CTF forwards the ACR to the OFCS. The ACR includes a retransmission indictor when the ACR being retransmitted. Ones of the plurality of CCF receive one or more ACRs from the one or more first-type network elements. The ones of the plurality of CCF construct a Charging Data Record (CDR) using charging information in the one or more ACR received. The CDR include an indicator that the CDR has used a potentially retransmitted ACR and an identification of one or more usage containers that are reported by the CDR.

In one embodiment, the indicator comprises one or more of portion of payload information of the potentially retransmitted ACR, an accounting record number (ARN), calling party address, called party address, service request time, delivery start time, delivery end times, and list of media components utilized.

In one embodiment, the identification of one or more usage containers lists one or more contained accounting record numbers (ARNs).

In one embodiment, the system also includes a Billing Domain (BD) connected to the OFCS. The BD receives a set of CDRs from a set of the plurality of CCF. The BD reconciles the set of CDRs to generate non-overlapped session CDRs based on the indicator and the identification of at least one of the set of CDRs.

In one embodiment, the BD reconciles by extracting from the set of CDRs billing information that is not duplicated and adjusting one or more of timestamps or media components of at least one of the set of CDRs.

Another embodiment comprises a non-transitory computer-readable medium that stores program instructions for providing offline charging in one or more network elements of a communication network that serves a session for User Equipment (UE). The program instructions, when executed by a computer system, cause the computer system to perform one or more portions of the methods described above and herein

Other exemplary embodiments may be described below.

### DESCRIPTION OF THE DRAWINGS

Some embodiments of the invention are now described, by way of example only, and with reference to the accompanying drawings. The same reference number represents the same element or the same type of element on all drawings.

FIG. 1 illustrates a communication network in an exemplary embodiment.

FIG. 2 illustrates a Long Term Evolution (LTE) network in an exemplary embodiment.

FIG. 3 is an illustration of accounting session failover and inclusion of vector components in CDR according to an example embodiment.

FIG. 4 shows an example enhanced CDR according to the principles of the invention that includes a list of retransmitted records field and a list of contained accounting record number (ARN) field.

FIG. 5 illustrates an example embodiment of the list of retransmitted records field.

FIG. 6 illustrates an example embodiment of the list of contained ARN field.

FIG. 7 is a flow chart illustrating an example method of generating an enhanced CDR according to the principles of the invention.

FIG. 8 is a flow chart illustrating an example method of reconciling billing based on the information included in enhanced CDR according to the principles of the invention.

FIG. 9 depicts a high-level block diagram of a computer suitable for use in performing functions described herein.

While the disclosed subject matter is amenable to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the scope of the appended claims.

### DESCRIPTION OF EMBODIMENTS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

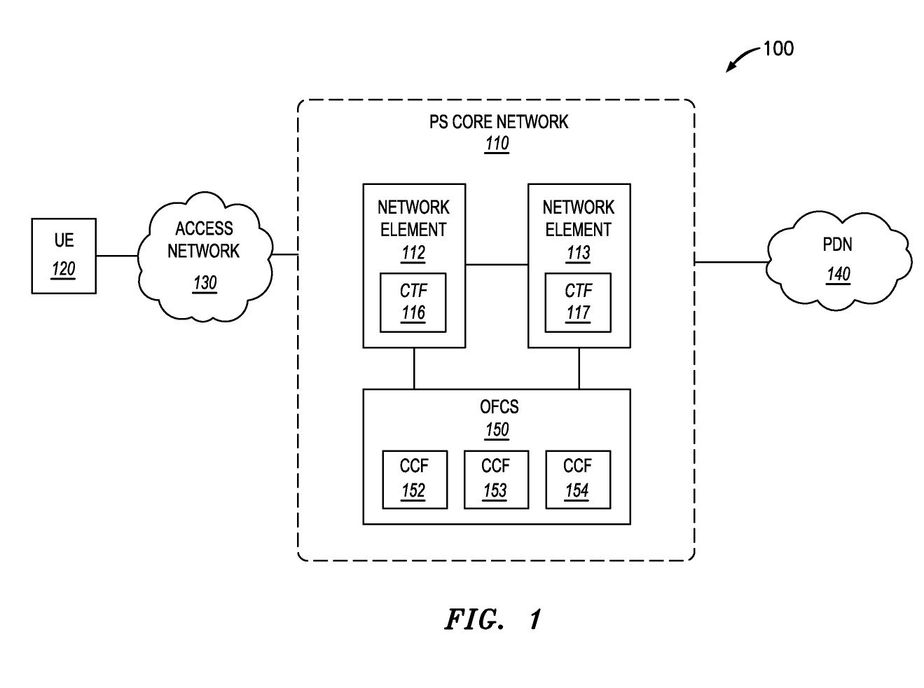

FIG. 1 illustrates a communication network 100 in an exemplary embodiment. Communication network 100 may represent a Long Term Evolution (LTE) network, an IP Multimedia Subsystem (IMS) network, or another type of Third Generation (3G) or Fourth Generation (4G) communication network. Network 100 includes a Packet-Switched (PS) core network 110 that provides various services to end user devices. One example of PS core network 110 is an Evolved Packet Core (EPC) network. In this embodiment, PS core network 110 includes network elements 112-113 that are each able to provide services. One example of network element 112 may be a Serving Gateway (S-GW) of an EPC network as described in the LTE standards. One example of network element 113 may be a Packet Data Network Gateway (PDN-GW) of an EPC network as described in the LTE standards. Other examples of network elements 112-113 may be a Mobility Management Entity (MME), an Application Server (AS), etc. PS core network 110 may include many more network elements that are not shown in FIG. 1 for ease of illustration.

PS core network 110 provides data services to User Equipment (UE) 120 (and other UEs not shown). UE 120 may be a mobile device (e.g., a mobile phone), a computer, a tablet, etc. UE 120 is able to access PS core network 110 through access network 130. Access network 130 comprises any type of network that interfaces UEs with PS core network 110. One example of access network 130 is a Radio Access Network (RAN), such as a UMTS Terrestrial Radio Access Network (UTRAN), an enhanced UTRAN (E-UTRAN), an Interworking-Wireless Local Area Network (I-WLAN), etc. PS core network 110 also connects to one or more external Packet Data Networks (PDN) 140, such as the internet.

Within PS core network 110, network elements 112-113 each include a Charging Trigger Function (CTF) 116-117, respectively. A CTF comprises any entity that generates charging events based on the observation of network resource usage. The CTF is the focal point for collecting information pertaining to chargeable events within a network element, assembling this information into matching charging events, and sending these charging events towards a charging function in the form of Accounting Requests (ACRs). A CTF is implemented in each network element or service element that provides charging information. Therefore, CTF 116 is illustrated in FIG. 1 as being embedded in network element 112, and CTF 117 is illustrated in FIG. 1 as being embedded in network element 113.

PS core network 110 also includes an Offline Charging System (OFCS) 150. OFCS 150 comprises any system, server, or function operable to provide offline charging for services/sessions accessed by end users, such as UE 120. OFCS 150 includes a group of peer Charging Collection Functions (CCF) 152-154 used for offline charging. A CCF 152-154 is configured to receive ACRs (i.e., information related to charging events) from network elements, and use the charging information contained in the accounting requests to construct Charging Data Records (CDRs). One example of a CCF 152-154 is a Charging Data Function (CDF) (and/or along with Charging Gateway Function (CGF)) as defined by the 3GPP in TS 32.240 (Release 6) hereby incorporated by reference. The purpose of offline charging is to transform the charging information into CDRs that are post-processed within a Billing Domain (BD) for the purpose of generating bills.

Offline charging can be categorized into two distinct classes: event-based charging and session-based charging. In event-based charging, a chargeable event is defined as a single end-user-to-network transaction, such as sending a multimedia message. The single transaction is mapped to a charging event, which results in a single CDR. In session-based charging, a user session is established resulting in the generation of multiple chargeable/charging events and the generation of one or more CDRs. In session-based charging, at least two charging events are needed for each session. One charging event describes the start of the session, and the other charging event describes the end of the session. Multiple other charging events, so called interim charging events, may also be utilized to describe changes to session characteristics (i.e., change of charging conditions), when a time limit is reached, when a volume limit is reached, etc.

The CTFs 116-117 described herein store charging characteristics for offline charging. The charging characteristics identifying subscriber charging account routing may be provided by a subscriber charging profile which stored in network database, such as a Home Subscriber Server (HSS), or may be a default subscriber charging profile stored in any network element node. The charging characteristics define triggers for reporting charging events to OFCS 150 when an offline charging is defined for subscriber in particular the session and/or service data flow. One of the triggers that may be stored by a CTF is a time limit between charging events. The CTF maintains a counter of the time since it last reported an accounting request to OFCS 150, and is configured to trigger or report an interim accounting request to OFCS 150 upon expiry of the time limit Another one of the triggers that may be stored by a CTF is a data volume limit. The CTF maintains a counter of the amount of data consumed (downlink and/or uplink) for an end user device during a session, and is configured to trigger an interim accounting request to OFCS 150 if the volume of data consumed exceeds the data volume limit. The charging characteristics may include other triggers for charging events that are not discussed herein. The data volume limit and the time limit are but two (2) of a number of reasons (e.g., approximately twenty (20) reasons why an LTE NE/CTF would report via an ACR Interim. Common reasons for the generation of ACR Interims in the IMS and VoLTE segments include: change in session characteristics, via, for example, inclusion of a new media component via Session Description Protocol (SDP) request/response between User Agent Clients (UACs) on the UEs in the session, or change in Quality of Service (QoS),

In FIG. 1, assume that UE 120 registers with network 100 in order to receive services, and requests a data session. A session as described herein may be referred to as an IP Connectivity Access Network (IP-CAN) session. An IP-CAN session is an association between UE 120 represented by an IPv4 address and/or an IPv6 prefix, and PDN 140. An IP-CAN session may incorporate one or more IP-CAN bearers. An IP-CAN bearer is an IP transmission path of defined capacity, delay and bit error rate, etc. Each IP-CAN bearer may be made up of one or more Service Data Flows (SDF), which is a flow of packets.

If a session initiates and network element 112 activates a bearer for the session (e.g., an IP-CAN bearer), then CTF 116 of network element 112 identifies an initial chargeable event responsive to the start of the session. The start of a “session” may refer to the start of an IP-CAN bearer, the start of a service data flow for an IP-CAN bearer, the start of an IP Multimedia Subsystem (IMS) session, etc. CTF 116 generates an initial accounting request (i.e., initial ACR) for the session responsive to the initial chargeable event, and transmits the initial accounting request to OFCS 150 where the session is assigned to one of the CCF 152-154 to initiate session-based offline charging for the session. The initial accounting request generated by CTF 116 may comprise a Diameter Rf ACR[Start]. In response to the initial accounting request, an assigned CCF, for example CCF 152 will open a Charging Data Record (CDR) for network element 112. As network element 112 continues to serve the session, CTF 116 may encounter other trigger conditions for reporting interim charging events to OFCS 150.

In the context of offline charging, a Charging Trigger Function (CTF) can failover from one Charging Collection Function (CCF) to another CCF in the middle of an accounting session upon concluding that the first CCF is unreachable or unresponsive (i.e., failure detection). This conclusion is usually accomplished via monitoring the path between the CTF and the CCF at the higher protocol level, for example, Diameter over either Stream Control Transmission Protocol (SCTP) or Transmission Control Protocol (TCP)/Internet Protocol (IP) via use of Device-Watchdog-Request/Answer (DWR/DWA) mechanism as the base Diameter protocol (as described in IETF RFC 3588/6733 hereby incorporated by reference), or at the level of transmission protocol itself via detection of timeout. As a result, the CTF sends part of the accounting session to one CCF, and the remaining part of the accounting session to the other CCF, assuming there are no further glitches. ACR of the remaining part of the accounting session sent to the another CCF may be marked as “retransmitted” if the CTF first attempted to send the ACR to the one CCF. Any ACR that is resent is marked as potentially duplicate, with the retransmission bit set, whether the ACR be to the same CCF twice, or different CCFs.

ACR retransmission and failover cause billing issues for a service provider. Receiving ACRs that are out-of-sequence, or receiving the ACRs for a session across more than one CCF with a retransmission indictor set places uncertainty around session coverage since the extent of overlap, if any, can not be determined at the service provider's Billing Domain (BD).

A CTF detects failure of a CCF upon concluding that the CCF is unreachable or unresponsive. When failure detection occurs at the Diameter level, it results from the CTF not receiving an answer/acknowledgment (ACA) for a previously sent accounting request (ACR) within a timeout period. For instance, when the initially transmitted ACR goes unanswered, the CTF may re-transmit that ACR a fixed number of times to the original CCF, each time waiting the length of a timer to get a response. These re-transmitted ACRs are sent with the T-flag set in the Diameter header to declare them as ‘potentially retransmitted’ ACRs, since from the CTF perspective, it is not possible to determine if (a) the CCF in question never received the original ACR due to network issues or (b) the CCF in question received the original ACR, but the response thereto was never delivered to the CTF due to network or other issues. In certain cases, if the original ACR was received by the CCF, the re-transmitted ACR with the T-flag set in the Diameter header can simply be discarded, as the CCF is able to reliably detect the duplication. In other cases, when a failover actually occurs, the re-transmitted ACR is sent to another CCF and this new CCF (i.e., the another CCF) simply accepts the re-transmitted ACR, even though it is marked as a potentially duplicate ACR. The new CCF, when generating a CDR at the end of the accounting session (be it a partial CDR or final session CDR), marks the CDR as being constructed from using a re-transmitted ACR.

3GPP standards specifications address duplicate detection in a variety of ways. For example, a Diameter client is to mark possible duplicate request messages (e.g., retransmission due to the link fail over process) with the T-flag as described in RFC 3588 If a 3GPP Charging Data Function (CDF) receives a message that is marked as retransmitted and this message was already received by the CDF, then the CDF discards the duplicate message. However, if the original of the re-transmitted message was not yet received, the information in the message marked re-transmitted is taken into account when generating the CDR. The CDRs also are marked if information from duplicated message(s) is used in their construction.

The CDRs produced in such cases have a simple indication if a re-transmitted ACR was used in the construction of the CDR. From 3GPP TS 32.298, hereby included by reference, examining any CDR syntax (the ‘*’ in front of the Record indicates use of a wildcard, which is to say that it applies to multiple CDRs, such as AS CDR, S-CSCF CDR, P-CSCF CDR and so on), the following are the first few components of the CDR:

| | |
|---|---|
| *Record | ::= SET |

{

| | |
|---|---|
| recordType | [0] RecordType, |
| retransmission | [1] NULL OPTIONAL, |
| sIP-Method | [2] SIP-Method OPTIONAL, |
| role-of-Node | [3] Role-of-Node OPTIONAL, |

..

}

3GPP TS 32.298 further states that the retransmission parameter, when present, indicates that information from retransmitted Diameter ACRs has been used in this CDR. The retransmission parameter is a simple flag.

However, duplicate detection and a simple indicator of the use of retransmitted Diameter ACR in finalized CDRs are insufficient for any meaningful reconciliation to avoid over-billing or under-billing; the finalized CDRs only contain an indicator and no quantitative information related to retransmitted ACRs that were failed over. The retransmission parameter and its indication that retransmitted Diameter ACRs were used to construct the CDR are not particularly helpful for billing reconciliation as the examples below clarify:

### Example 1

### Temporary Failure of a Routing Component

Consider the following messaging exchange detailing 1) transmission of an ACR from CTF to CCF, 2) failure to get a response from the CCF, 3) retransmission of the ACR, and 4) acknowledgement received by the CTF from the CCF:

1. CTF→ACRn→CCF

2. CTF does not get a response within expected time period.

3. CTF→ACRn with T-flag set→CCF (retry)

4. CTF←ACA←CCF

Assume the reason for failure at steps 1/2 was a temporary route failure; for example, a Diameter relay failed and was Out of Service (OOS) for a period of time longer than the timer set on the CTF for expecting a response. At step 3, when the CTF retransmits the ACR, the network takes this ACR via a different route to the CCF. The ACR is registered and acknowledged by the CCF and the acknowledgement received by the CTF.

When the affected relay is back in service, the relay will replay buffered messages that were not sent to the CCF before the relay went OOS. This replayed ACR may then be acknowledged by the CCF and the acknowledgement received by the CTF. Therefore, the messaging exchange would be:

5. →Diameter Relay→ACRn→CCF

6. CTF←ACA←CCF

If the edge case is assumed, with ACRn being an ACR Stop message, steps 1 through 4 resulted in the production of a complete CDR, with indication that the CDR encompasses a retransmitted ACR (ACRn). Steps 5-6 also resulted in the production of a CDR—an Incomplete CDR—with just ACRn.

### Example 2

### Failover on Account of Temporary Failure of a Single CCF

Consider the following messaging exchange detailing failover from a first CCF to a second CCF:

1. CTF→ACRm→CCF1

2. CTF does not get a response within expected time period.

3. CTF→ACRm with T-flag set→CCF1 (retry)

4. CTF does not get a response within expected time period and fails over to CCF2.

5. CTF→ACRm→CCF2 with T-flag set

6. CTF←ACA←CCF2

7. Further ACR/ACA sent/received until the end of the session.

In this example, the first part of the session is handled at CCF1; the CTF cannot determine if ACRm was received and used at CCF1 due to the lack of reception of an acknowledgement; and, the BD likewise cannot determine the overlap between the two (2) CDRs. Complications may arise at steps 2 through 5. For example, if CCF1 indeed received ACRm, but ACAm was lost in the transmission, then the CTF does not know this fact, and neither does CCF1. Accordingly, the CDR generated at CCF1 would include ACRm (as it was acknowledged via ACAm) and the CDR may not contain any retransmission indication. Alternatively, if the ACR at step 1 was missed, but the ACR at step 3 was received, then the generated CDR would contain the retransmission indicator. In this alternative case, the failover for CTF would not be necessary. A tricky situation also arises if the timeout at the CTF is very close to the time the ACAm from CCF1 is received by the CTF and the CTF has already initiated a failover to CCF2 and sent ACRm (with T-flag) to CCF2.

### Example 3

### Dual Failover within a Session

When the CTFs are directly connected to the CCFs without a DRA (Diameter Routing Agent) in between, dual failover within a session is less frequently observed. Nevertheless, this use case is nonetheless important as service providers begin and/or continue to deploy DRAs, since in-session recovery of a previously failed CCF can force the session back to the restored CCF.

Consider the following messaging exchange:

1. CTF→DRA→ACRm CCF1

2. CTF does not get a response within expected time period.

3. CTF→DRA→ACRm with T-flag set→CCF1 (retry)

4. CTF does not get a response within expected time period and fails over to CCF2.

5. CTF→DRA→ACRm→CCF2 with T-flag set

6. CTF←DRA←ACA←CCF2

7. Additional ACR/ACA between the CTF and CCF2, until CCF2 develops error.

8. CTF→DRA→ACRn→CCF2

9. CTF does not get a response within expected time period.

10. CTF→DRA→ACRn with T-flag set→CCF2 (retry)

11. CTF does not get a response within expected time period and fails back to CCF1, which has now recovered.

12. After a few more ACR have been exchanged, the session ends.

In this case, depending on the particular conditions, the CDR generated both by CCF1 and by CCF2 may show ‘Incomplete CDRs’ and in both cases, the ‘retransmission’ indicator would be set. However, since both ACRm and ACRn are variables that are not known to the BD (i.e., the particular ACR record/s retransmitted are not know), the BD would not be able to reconcile these records, reconciliation being desirable as both CDR records likely would overlap.

Other examples may be described, but it is sufficient to say that receiving ACRs that are out-of-sequence, or receiving ACRs for a session across more than one (1) CCF with the T-flag set creates uncertainty around session coverage and the extent of overlap, if any, can not be determined at the BD.

With respect to LTE, the CCF report usage containers. These containers reflect service differentiation used in flow-based bearer charging, where the PDN Gateway (PGW) reports usage in SDC (Service Data Containers) and the Serving Gateway (SGW) reports using TDV (Traffic Data Volume) containers. Reporting based on containers is an added complexity and the downstream billing system (e.g., BD in this example) is tasked with reconciling the CDRs with different containers, some of which may be repeated across two (2) or more CDRs, with only the simple indication that the CDRs used retransmitted information. Moreover, CDRs generated from PGW and SGW do not even contain a ‘retransmission’ field.

While detecting use of retransmitted ACRs across multiple CDRs produced for the same session may be perceived to be easy, reconciling the CDRs via removal of any overlapping information to prevent overbilling an end user device is extremely difficult. As a consequence, such CDRs are routinely discarded and the network operator is subject to revenue leaks.

Accordingly, provided herein are embodiments in which, when a CCF creates a CDR which uses one or more potentially duplicate ACR, the CDR includes:

1) an indicator that the CDR has used a potentially retransmitted ACR; and

2) the identify of one or more usage containers (described further in this disclosure) that are reported with the CDR.

With the inclusion of this information, a downstream billing domain system is able to handle multiple incomplete CDRs per session, extracting the information that is not duplicated and reconciling between these CDRs to generate a non-overlapped session reporting entity. This information can be included by extending the format of CDRs created by CCFs.

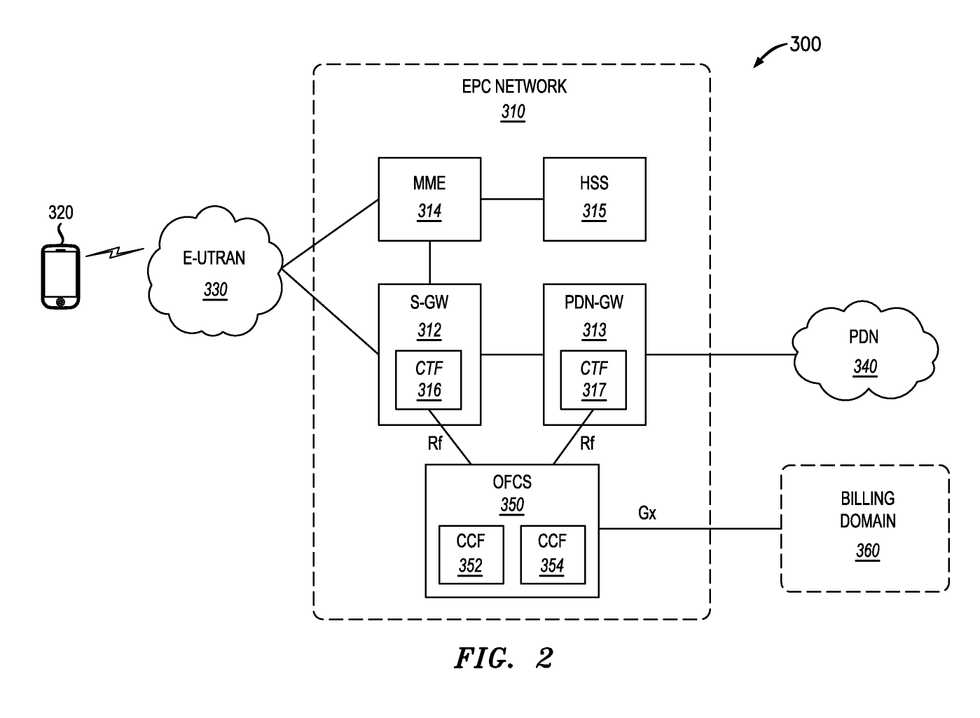

FIG. 2 illustrates a Long Term Evolution (LTE) network 300 in an exemplary embodiment. LTE network 300 includes an Evolved Packet Core (EPC) network 310 in which a UE 320 is subscribed to a service plan. EPC network 310 includes a Serving Gateway (S-GW) 312, a PDN Gateway (PDN-GW) 313, a Mobility Management Entity (MME) 314, and a Home Subscriber Server (HSS) 315. The illustrated network elements of an EPC network are shown as an example, and EPC network may include other network elements not shown.

S-GW 312 is the gateway that terminates the interface from EPC network 310 towards E-UTRAN 330. S-GW 312 is responsible for transferring the data packets for a session across the user plane. PDN-GW 313 is the gateway that terminates the interface from EPC network 310 to an external Packet Data Network (PDN) 340. PDN-GW 313 is responsible for connectivity between UE 320 and PDN 340 by being the entry/exit point of traffic. MME 314 is responsible for tracking the location of UE 320, and paging UE 320 for communications. HSS 315 is a central database that stores subscription information for end users. For example, HSS 315 may store subscriber profiles that indicate which services an end user subscribes to in EPC network 310.

The following example illustrates an offline charging system within LTE network 300. To implement offline charging, a Charging Trigger Function (CTF) 316 is embedded in S-GW 312, and a CTF 317 is embedded in PDN-GW 313. CTFs of the PGW and SGW are enhanced to include a ‘retransmission’ field in ACRs the PGW and SGW create. LTE network 300 also includes Offline Charging System (OFCS) 350 including Charging Collection Function (CCF) 352-354. CTFs 316-317 are connected to OFCS 350 and CCF 352-254 over a Diameter Rf reference point. The CDRs generated by CCF 352-354 are enhanced as described herein. OFCS 350 and CCF 352-354 are also connected to the Billing Domain (BD) 360 over a Diameter Bx reference point.

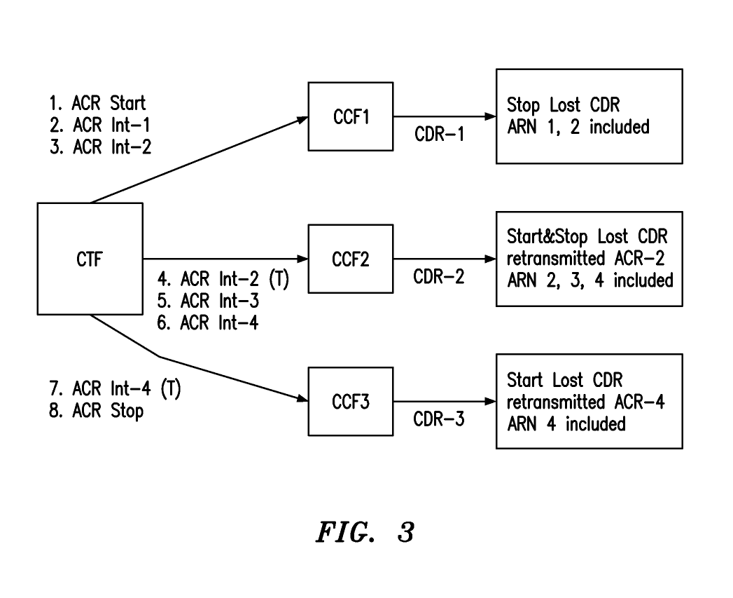

According to one or more embodiments, a CDR is enhanced with an indicator that the CDR has used a potentially retransmitted ACR and the identify of one or more usage containers that are reported with the CDR. For further discussion of the enhanced CDR an example record from Application Server (AS) will be utilized for two reasons. First, the AS is involved in all sessions in the IMS and VoLTE domain. Second, current standards allow for reflecting the ‘retransmission’ indicator in the AS CDR. FIG. 3 is an illustration of accounting session failover and inclusion of vector components in CDR according to an example embodiment of the invention. For purposes of the example, the following messaging exchange involving retransmission and failover is given:
1. The AS (i.e., CTF of AS) starts a session reporting to CCF1 and sends the ACR Start to CCF1.
2. The AS successfully sends ACR Interim 1 to CCF1.
3. The AS sends ACR Interim 2 to CCF1, and does not get a response, as CCF1's response does not get back to the AS.
4. The AS fails over to CCF2 and transmits the ACR Interim 2 with the T-flag set.
5. The AS successfully sends ACR Interim 3 to CCF2.
6. The AS sends ACR Interim 4 to CCF2, and does not get a response, as CCF2's response does not get back to the AS.
7. The AS fails back to CCF1 and transmits ACR Interim 4 with the T-flag set (in FIG. 3, this is shown as a failover to CCF3, which would be a similar case to the one being presented here).
8. The AS sends a final ACR Stop to CCF1 and the session ends.

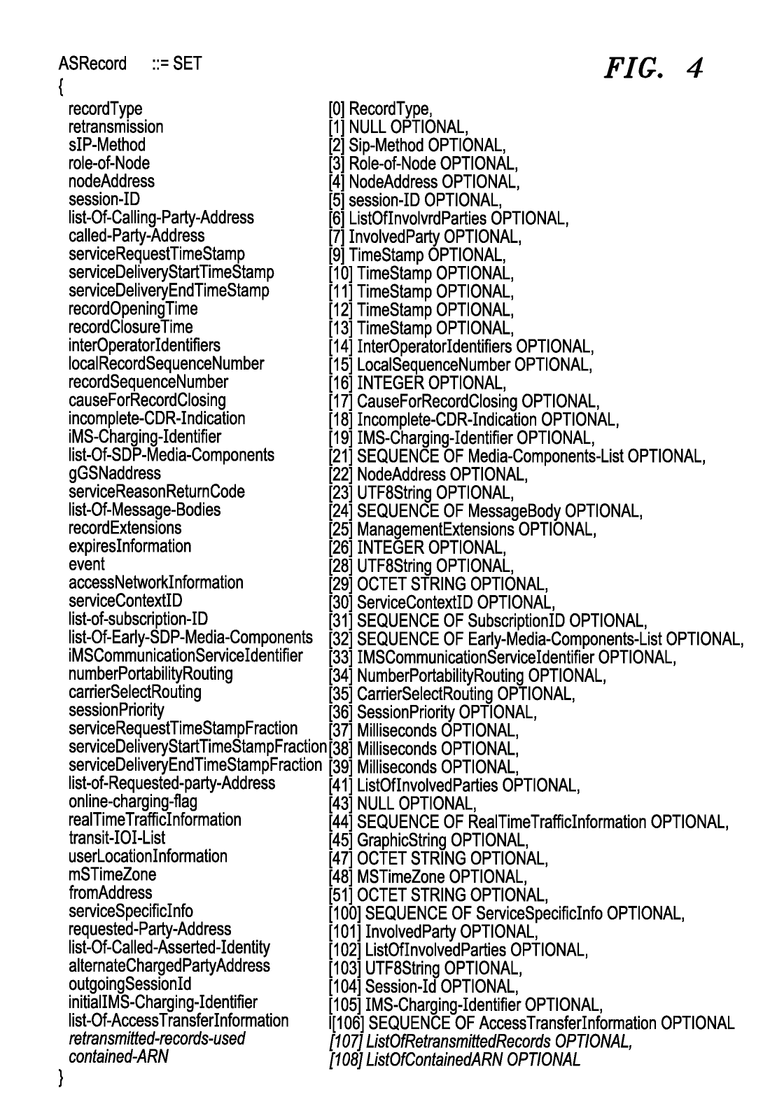

FIG. 4 shows an example enhanced CDR according to the principles of the invention. According to one or more embodiments, conventional CDR structures are extended to include information on retransmitted ACRs used in constructing the CDR and then also to include the identification of all Accounting Record Numbers that were used in creation of the CDR. The CDR illustrated in FIG. 4 is that of the AS Record which is defined in 3GPP TS 32.298 Release 11. Specifically, the figure illustrates that the fields retransmitted-records-used and contained-ARN have been added to the conventional AS record. A similar enhancement applies to all other CDR records that contain information about ‘retransmission’ (e.g., SCSCF/PCSCF/ICSCF Records (Serving/Proxy/Interrogating Call Session Control Function), Media Resource Function Controller (MRFC) Record, Breakout Gateway Control Function (BGCF) Record, Emergency CSCF (ECSCF) Record, Interconnection Border Control Function (IBCF) Record, Transit & Roaming Function (TRF) Record, Transit Function (TF) Record and Access Transfer Control Function (ATCF) Record, PGW Record and SGW Record. SDCs and TDVs that are sent in a retransmitted ACR are appended to a CDR so that each CDR that uses a potentially retransmitted ACR identifies the ARN and the containers that were reported. The consequent changes in the CDR structure required to reflect this date capture are within the skills of one in the art of the invention.

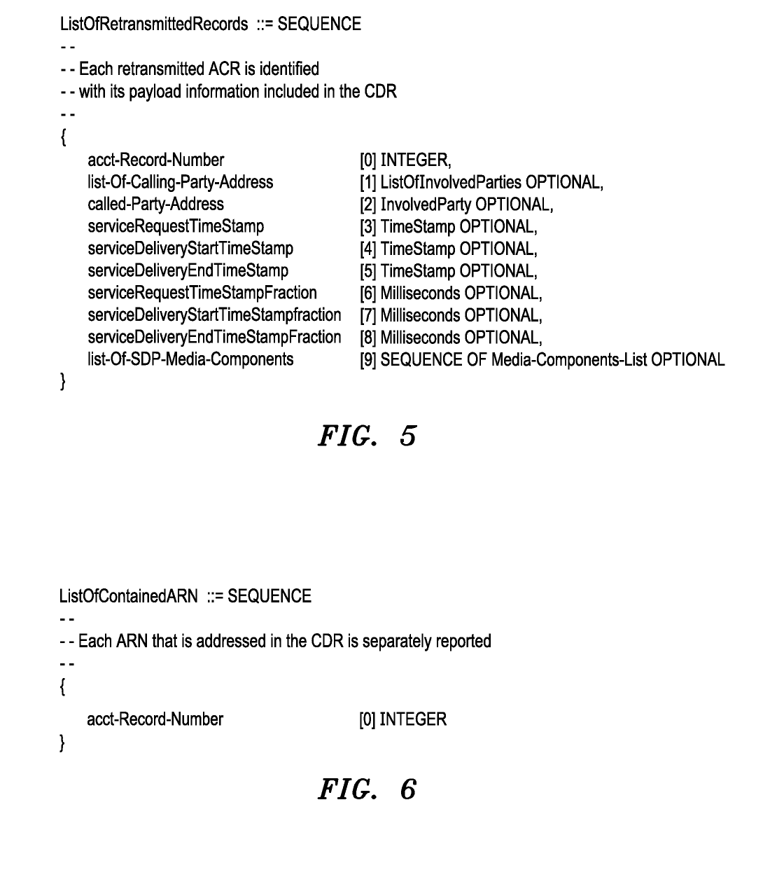

The newly included CDR fields in ASN.1 may be defined as illustrated in FIG. 5 and FIG. 6. FIG. 5 illustrates an example embodiment of the list of retransmitted records field. For example, each retransmitted ACR may be identified with some portion its payload information included in the generated CDR. Such payload information may include one or more of the accounting record number, calling party address, called party address, service request time, delivery start and end times, list of media components utilized.

FIG. 6 illustrates an example embodiment of the list of contained accounting record number (ARN) field. For example, the list may be a sequence in which each accounting record number that is addressed in the CDR is separately reported.

For the example messaging exchange of FIG. 3, in the absence of a CCF embodiment according to the principles of the invention, the following is expected:
CCF1 would generate an Incomplete CDR based on ACR Start, ACR Interim-1 and ACR Interim-2.
CCF2 would generate an Incomplete CDR with retransmission indicator based on ACR Interim-2, 3 and 4.
The CCF1 (or CFF 3 as illustrated) would generate an Incomplete CDR with retransmission indicator based on ACR Interim-4 and ACR Stop
   If there is no reconciliation, the containers reported in ACR Interim-2 and ACR Interim-4 would be double-billed. Furthermore, if the BD cannot reconcile, it may be that none of the usage reported in the ACRs would be charged to the end user device. Thus, a network operator and/or its customers will be disappointed with these billing results.

For the example messaging exchange of FIG. 3, embodiments of CCF according to the principles of the invention would produce the following CDRs:
The CCF1 would generate an Incomplete CDR based on ACR Start, ACR Interim-1 and ACR Interim-2 and report the ListOfContainedARN as 1, 2.
The CCF2 would generate an Incomplete CDR with retransmission indicator based on ACR Interim-2, 3 and 4 and include in the ListOfRetransmittedRecords information about ACR Interim-2 and in ListOfContainedARN, as 2, 3, 4.
The CCF1 (or CFF 3 as illustrated) would generate an Incomplete CDR with retransmission indicator based on ACR Interim-4 and ACR Stop. In addition, it would include in the ListOfRetransmittedRecords information about ACR Interim-4 and the ListOfContainedARN would carry information about ARN 4, 5 (Stop).

Accordingly, with the same charging identifier, for example IMS Charging Identifier (ICID), used across the three (3) CDRs, the BD can collate these CDRs for reconciliation purposes. Given the following information from the CDRs:

ICID=xyz, CDR-1, Incomplete CDR, no retransmitted ACRs, contains ARNs 1,2;

ICID=xyz, CDR-2, Incomplete CDR, used retransmitted ACR identified via ARN 2, description of retransmitted ACR, contains ARNs 2, 3, 4; and

ICID=xyz, CDR-3, Incomplete CDR, used retransmitted ACR identified via ARN 4, description of retransmitted ACR, contains ARNs 4, 5;

the BD is then able to recognize the overlapped coverage in the CDRs 1-3, as the component carried in ARN 2 is captured in CDR-1 as well as CDR-2, and the component carried in ARN 4 is captured in CDR-2 as well as CDR-3.

Left alone, these duplications give rise to double billing. However, with clearly identified duplicated components according to the principles of the invention, the BD is able to extract the components that would give rise to duplication and eliminate them as follows: No adjustment to CDR-1 (ICID=xyz, Incomplete CDR, no retransmitted ACRs, contains ARNs 1,2).

CDR-2 adjusted via elimination of ARN 2 (ICID=xyz, Incomplete CDR, no retransmitted ACR, contains ARN 3, 4).

CDR-3 adjusted via elimination of ARN 4 (ICID=xyz, Incomplete CDR, no retransmitted ACR, contains ARN 5).

The process of ARN elimination/exclusion may include adjusting one or more timestamps and/or one or more media components of a CDR. Continuing with the example under discussion, timestamps may be adjusted by aligning the CDR-2 request and delivery time stamps and timestamp fractions based on the information contained in the ListOfRetransmittedRecords. The result of this alignment is such that the start time stamp for CDR-2 coincides with the serviceDeliveryEndTimeStamp and fraction in the ListOfRetransmittedRecords for ARN 2 and the service delivery end time stamp for CDR-2 remains unchanged, as before from ARN 4. Continuing with the example under discussion, SDP Media Components may be adjusted such that the reported SDP Media Components for a CDR considers the previously reported CDR (in time sequence), and the subsequent CDR to extract out the SDP Media Components exclusively established by a retransmitted ACR. For instance, with respect to the example, if CDR-1 has SDP Media Components ‘a’ and ‘b’, and the CDR-2 has SDP Media Components ‘a’, ‘b’ and ‘c’, then since ARN 2 is repeated in CDR-1 and CDR-2, it can be inferred that component ‘c’ was introduced in ARN 3 or 4. Further, examining the media components in the CDR-3 can predict further if the media change occurred via ARN 4 or ARN 5.

The information provided in CDRs may also be utilized to generate a single consolidated CDR. For instance, the BD can further establish that the timestamps in CDRs1-3 present a continuous stretch of time, and if desired, a single, complete CDR can be provided collapsing the three (3) CDRs above to present the appropriate picture. In many cases, this consolidation is useful for rating purposes, as three different smaller duration CDRs may be rated in a different way than a single and longer duration CDR.

When the networks charging routing becomes more complete and complex with Diameter Routing Agents, retransmitting and failover will cause a major billing issues for service providers. The solution provided by the embodiments herein resolved these issues with new CDRs constructed so as to enable reconciliation that prevents potential revenue loss. The embodiments will prove beneficial in IMS and LTE/EPC networks.

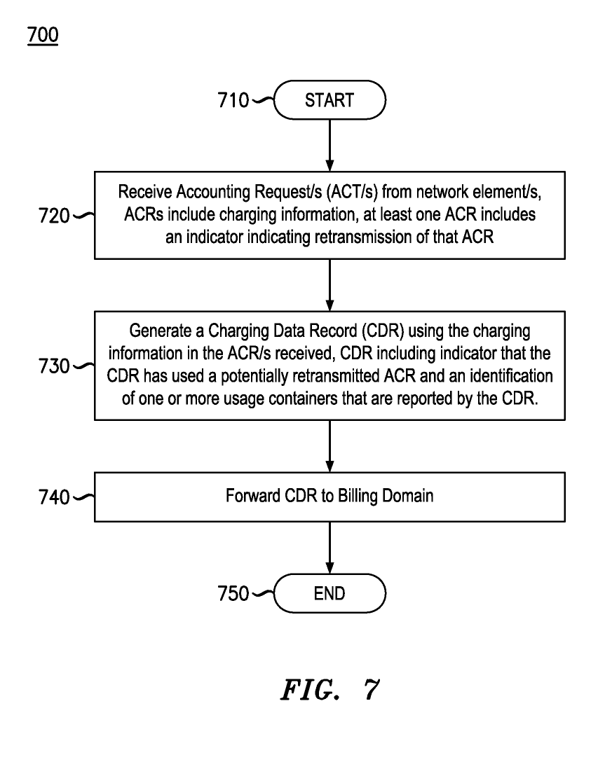

FIG. 7 is a flow chart illustrating an example method of generating an enhanced CDR according to the principles of the invention. The steps of method 700 will be described with reference to network element 350 in FIG. 2, but those skilled in the art will appreciate that method 700 may be performed in other systems. Also, the steps of the flow chart in FIG. 7 are not all inclusive and may include other steps not shown, and further, the steps may be performed in an alternative order.

At operation 710, the method starts.

At operation 720, an Accounting Requests (ACR) is received at a network node. Received at a first network node (e.g., OFCS 350, CCF 352, CCF 354) are one or more Accounting Requests (ACRs) from one or more network elements (e.g., SGW 312, CTF 316, PDN-DW 313, CTF 317). The ACRs include charging information. When ACRs are being retransmitted from a network element, the ACR includes an indicator indicating ‘retransmission’ of the ACR.

At operation 720, a Charging Data Record (CDR) is generated using the charging information in the one or more ACR received. The generated CDR includes an indicator that the CDR has used a potentially retransmitted ACR and an identification of one or more usage containers that are reported by the CDR. The indicator may include a portion of payload information of the potentially retransmitted ACR. For example, the portion of payload information may include an accounting record number (ARN), calling party address, called party address, service request time, delivery start time, delivery end times, list of media components utilized, or any combination thereof. The indicator may be a sequence of information concerning a plurality of potentially retransmitted ACR, each element of the sequence comprising a portion of payload information of a respective one of the plurality of potentially retransmitted ACR. The identification of one or more usage containers identifies each accounting record number that is included in the CDR.

At operation 730, the generated CDR is forwarded to a Billing Domain (BD) 360 for generation of a bill for an end user.

At operation 740, the method ends.

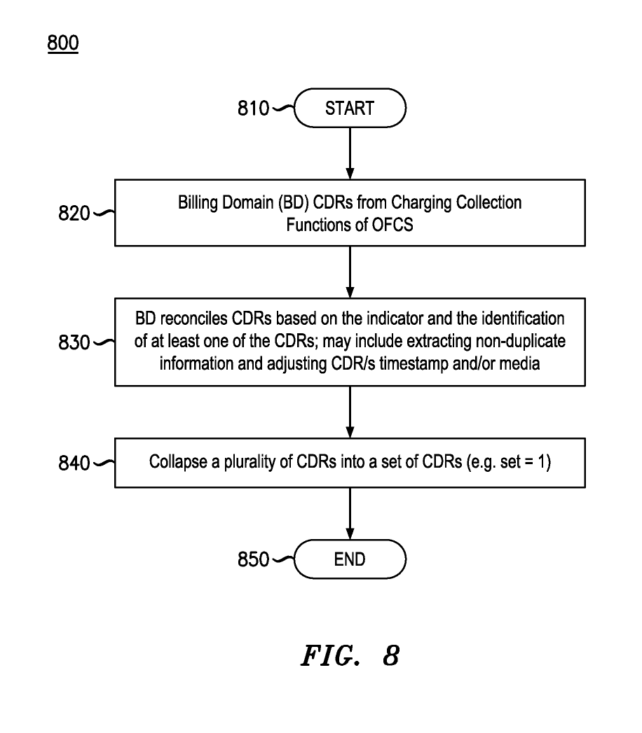

FIG. 8 is a flow chart illustrating an example method of reconciling billing based on the information included enhanced CDR according to the principles of the invention.

At operation 810, the method starts.

At operation 820, Billing Domain (BD) 360 receives a plurality of CDRs from a plurality of Charging Collection Functions 352-354 of an OFCS 350. For example, CDRs may be pushed or pulled to the BD.

At operation 830 the BD reconciles the plurality of CDRs to generate non-overlapped session CDRs. The reconciliation is based on the indicator and the identification of at least one of the plurality of CDRs. Reconciliation may include extracting from the plurality of CDRs billing information that is not duplicated and adjusting the billing information of one or more CDRs. For example, a timestamp of a CDR/s may be adjusted. For example, media components of a CDR may be adjusted.

At operation 840, a plurality of CDRs that have been adjusted are collapsed into a set of CDRs. The size of the set of CDRs is smaller in number than the size of the plurality of CDRs. For example, a set of CDRs can be collapsed into a single CDR.

At operation 850, the method ends.

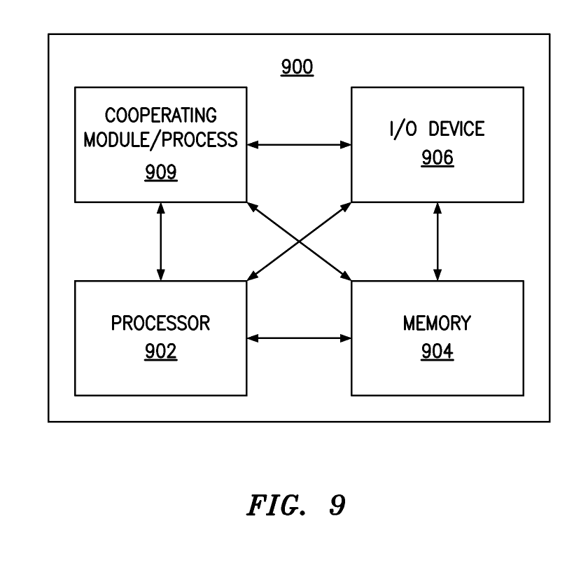

FIG. 9 depicts a high-level block diagram of a computer suitable for use in performing the functions described herein. The computer 900 includes a processor 902 (e.g., a central processing unit (CPU) or other suitable processor(s)) and a memory 904 (e.g., random access memory (RAM), read only memory (ROM), and the like).

The computer 900 also may include a cooperating module/process 905. The cooperating process 905 can be loaded into memory 904 and executed by the processor 902 to implement functions as discussed herein and, thus, cooperating process 905 (including associated data structures) can be stored on a computer readable storage medium, e.g., RAM memory, magnetic or optical drive or diskette, and the like.

The computer 900 also may include one or more input/output devices 906 (e.g., a user input device (such as a keyboard, a keypad, a mouse, and the like), a user output device (such as a display, a speaker, and the like), an input port, an output port, a receiver, a transmitter, one or more storage devices (e.g., a tape drive, a floppy drive, a hard disk drive, a compact disk drive, and the like), or the like, as well as various combinations thereof).

It will be appreciated that computer 900 depicted in FIG. 9 provides a general architecture and functionality suitable for implementing functional elements described herein or portions of functional elements described herein. For example, the computer 900 provides a general architecture and functionality suitable for implementing one or more of UE 120, portions of access network 130, network element 112-113, CTF 116-117, OFCS 150, CCF 152, and portions of PDN 140. Computer 900 is also suitable for implementing UE 320, portions of E-UTRAN 320, MME 314, HSS 315, SGW 312, PDNGW 313, CTF 316-317, OFCDS 350, CCF 352-354, portions of PDN 340, BD 360, and the like.

It will be appreciated that the functions depicted and described herein may be implemented in hardware or a combination of software and hardware, e.g., using a general purpose computer, via execution of software on a general purpose computer so as to provide a special purpose computer, using one or more application specific integrated circuits (ASICs) or any other hardware equivalents, or the like, as well as various combinations thereof.

It will be appreciated that at least some of the method steps discussed herein may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods or techniques described herein are invoked or otherwise provided. Instructions for invoking the inventive methods may be stored in fixed or removable media, transmitted via a data stream in a broadcast or other signal bearing medium, stored within a memory within a computing device operating according to the instructions, or embodied in a non-transitory media.

Portions of the disclosed subject matter and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non-volatile storage, logic, or some other physical hardware component or module.

Note also that the software implemented aspects of the disclosed subject matter are typically encoded on some form of storage medium or implemented over some type of transmission medium. The storage medium, such as a non-transitory storage medium, may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The disclosed subject matter is not limited by these aspects of any given implementation.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A method comprising:
receiving at a first network node one or more Accounting Requests (ACRs) from one or more network elements, the one or more ACRs including charging information, at least one of the one or more ACRs including an indicator indicating retransmission of the at least one ACR;
generating a Charging Data Record (CDR) using the charging information in the one or more ACR received, the CDR including
an indicator that the CDR has used a potentially retransmitted ACR; and
an identification of one or more usage containers that are reported by the CDR.

2. The method of claim 1 wherein the indicator comprises a portion of payload information of the potentially retransmitted ACR.

3. The method of claim 1 wherein the portion of payload information comprises one or more of an accounting record number (ARN), calling party address, called party address, service request time, delivery start time, delivery end times, and list of media components utilized.

4. The method of claim 1 wherein the indicator comprises a sequence of information concerning a plurality of potentially retransmitted ACR, each element of the sequence comprising a portion of payload information of a respective one of the plurality of potentially retransmitted ACR.

5. The method of claim 1 wherein the identification of one or more usage containers is a field that lists one or more contained accounting record numbers (ARNs).

6. The method of claim 1 wherein the identification is a sequence which identifies each accounting record number that is included in the CDR.

7. The method of claim 1 further comprising:
receiving at a Billing Domain (DB) a plurality of CDRs from a plurality of charging collection functions of an offline charging system; and
reconciling the plurality of CDRs to generate non-overlapped session CDRs based on the indicator and the identification of at least one of the plurality of CDRs.

8. The method of claim 7 wherein said reconciling comprises:
extracting from the plurality of CDRs billing information that is not duplicated; and
adjusting one or more of a timestamp and a media component of at least one of the plurality of CDRs.

9. The method of claim 7 further comprising
collapsing the plurality of CDRs into a set of CDRs, a size of the set of CDRs smaller in number than a size of the plurality of CDRs.

10. An apparatus comprising:
a network element for a communication network for serving a communication session;
the network element configured to receive one or more Accounting Requests (ACRs) from one or more network elements, the one or more ACRs including charging information, respective ACRs including a retransmission indicator when the respective ACR is retransmitted;
the network element configured to construct a Charging Data Record (CDR) using the charging information in the one or more ACR received, the CDR including
an indicator that the CDR has used a potentially retransmitted ACR; and
an identification of one or more usage containers that are reported by the CDR.

11. The apparatus of claim 10 wherein the indicator comprises a portion of payload information of the potentially retransmitted ACR.

12. The apparatus of claim 10 wherein the portion of payload information comprises one or more of an accounting record number (ARN), calling party address, called party address, service request time, delivery start time, delivery end times, and list of media components utilized.

13. The apparatus of claim 10 wherein the indicator comprises a sequence of information concerning a plurality of potentially retransmitted ACR, each element of the sequence comprising a portion of payload information of a respective one of the plurality of potentially retransmitted ACR.

14. The apparatus of claim 10 wherein the identification of one or more usage containers is a field that lists one or more contained accounting record numbers (ARNs).

15. The apparatus of claim 10 wherein the identification is a sequence which identifies each accounting record number that is included in the CDR.

16. A system comprising:
one or more first-type network elements, each of the one or more first-type network elements including a Charging Trigger Function (CTF); and
an Offline Charging System (OFCS) including a plurality of Charging Collection Functions (CCF), the one or more first-type network elements connected to the OFCS;
the CTF for generating a charging event based on observation of network resource usage and for generating an Accounting Request (ACR) including charging information in response to the charging event,
the CTF for forwarding the ACR to the OFCS, the ACR including a retransmission indictor when the ACR being retransmitted,
ones of the plurality of CCF configured receive one or more ACRs from the one or more first-type network elements, the ones of the plurality of CCF configured to construct a Charging Data Record (CDR) using charging information in the one or more ACR received, the CDR including
an indicator that the CDR has used a potentially retransmitted ACR; and
an identification of one or more usage containers that are reported by the CDR.

17. The system of claim 16 wherein the indicator comprises one or more of portion of payload information of the potentially retransmitted ACR, an accounting record number (ARN), calling party address, called party address, service request time, delivery start time, delivery end times, and list of media components utilized.

18. The system of claim 16 wherein the identification of one or more usage containers lists one or more contained accounting record numbers (ARNs).

19. The system of claim 16 further comprising:
a Billing Domain (BD) connected to the OFCS;
the BD for receiving a set of CDRs from a set of the plurality of CCF,
the BD for reconciling the set of CDRs to generate non-overlapped session CDRs based on the indicator and the identification of at least one of the set of CDRs.

20. The system of claim 16 wherein the BD is configured to perform said reconciling by:
extracting from the set of CDRs billing information that is not duplicated; and
adjusting one or more of timestamps or media components of at least one of the set of CDRs.
